(19) United States
(12) Patent Application Publication
(10) Pub. No.: US 2009/0178729 A1
(43) Pub. Date: Jul. 16, 2009

(54) DEVICE FOR TRANSFER OF SUBSTANCES BETWEEN CONTAINERS

(76) Inventors: Guy Ben Zur, Skokie, IL (US); Itamar Burstein, Tel Aviv (IL); Tal E. Ben Shlomo, Ramat Hasharon (IL); Lam Chan, Kwai Chung (HK)

Correspondence Address: Pearl Cohen Zedek Latzer, LLP, 1500 Broadway, 12th Floor, New York, NY, 10036, US

(21) Appl. No.: 12/013,714

(22) Filed: Jan. 14, 2008

(51) Int. Cl. B67C 11/02

(52) U.S. Cl. 141/331

(57) ABSTRACT

A funnel for introducing and dispensing a material may include a first hollow frusto-conical structure including an intake port and a first exit port, where the diameter of said first exit port is smaller than the diameter of the intake port. The funnel may include a second hollow structure including a sealing element for sealing the first exit port. The second structure may mate with the first structure for forming a passage from the first structure through the second structure. Rotating the second structure with respect to the first structure may bridge a gap between the sealing element and the first exit port for sealing the passage. Other embodiments are described and claimed.

### FIELD OF THE INVENTION

The present invention generally relates to a funnel for directing the flow of material such as liquids, powders, or granular solids for example from a first container to a second container.

### BACKGROUND OF THE INVENTION

When cooking, it is often necessary to measure materials or pour materials from one container to another container, or to pour material from one large container, requiring two hands to manipulate, into a small opening. Although methods exist to perform these tasks, none are ideal. One such method is to first pour the material from the first container into a measuring cup to ensure the proper amount of material and to then pour the material from the measuring cup into a second container. Even if the measuring cup has a spout, it is difficult to ensure that all of the material flows into the second container without spilling. This is especially true if the second container has a narrow opening. A second method further improves the first method by employing a funnel which is inserted into the second container. Instead of pouring the material directly from the measuring cup, the material may be poured from the measuring cup to the funnel thus ensuring that none of the material spills. However, this method requires the purchase, storage, and cleaning of two separate pieces of equipment.

### SUMMARY OF THE INVENTION

A funnel or funnel system may include a first hollow frusto-conical structure including an intake port and a first exit port, where the diameter of the first exit port is smaller than the diameter of the intake port. The funnel may further include a second hollow structure including a sealing element or stopper for sealing the first exit port. The second structure may be adapted for mating with the first structure for forming a passage from the first structure through the second structure. Rotating the second structure with respect to the first structure may bridge a gap between the sealing element and the first exit port for sealing the passage.

A funnel may include a first hollow frusto-conical structure including an intake port and a first exit port. The funnel may further include a second hollow structure including a stopper or sealer. The second structure may be adapted for connecting with the first structure for forming a passage allowing material to flow from the intake port through the second structure. Rotating the second structure with respect to the first structure may move the stopper between a position spaced from the first structure for opening the passage and a position against the first exit port for sealing the passage.

A funnel may include an intake port and an exit port. The width of the intake port may be larger than the width of the exit port. The funnel may further include a hollow structure including a sealing structure. The width of the sealing structure may be smaller than the smallest width of the hollow structure. The sealing structure typically does not seal the hollow structure. The sealing structure may close the exit port when the hollow structure is rotated in a first direction. The sealing structure may allow material to flow out of the exit port and through the hollow structure when the hollow structure is rotated in a second direction.

### DESCRIPTION OF THE DRAWINGS

Various embodiments of the present invention are illustrated in the following drawings, which are meant to be exemplary only and are not limiting on the scope of the present invention, and in which

FIG. 1 is a side view drawing of a funnel in accordance with one embodiment of the present invention;

FIG. 2 is a front view drawing of the funnel of FIG. 1, rotated 90 degrees from FIG. 1, in accordance with one embodiment of the present invention;

FIG. 3 is a top view drawing of the funnel of FIGS. 1-2, in accordance with one embodiment of the present invention;

FIG. 4 is an isometric view drawing of the funnel of FIGS. 1-3, in accordance with one embodiment of the present invention;

FIG. 5a is a side view drawing of a funnel having a reference axis, in accordance with one embodiment of the present invention;

FIG. 5b is a cross-sectional view drawing of the funnel of FIG. 5a taken along the reference axis of FIG. 5a, in accordance with one embodiment of the present invention;

FIG. 5c is a top view drawing of a structure of the funnel of FIG. 5b, in accordance with one embodiment of the present invention;

FIG. 6a is an exploded view of the parts of an embodiment a funnel, in accordance with one embodiment of the present invention; and

FIG. 6b is a cutaway view of parts of the funnel of FIG. 6a, in accordance with one embodiment of the present invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DESCRIPTION OF THE PREFERRED EMBODIMENT

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

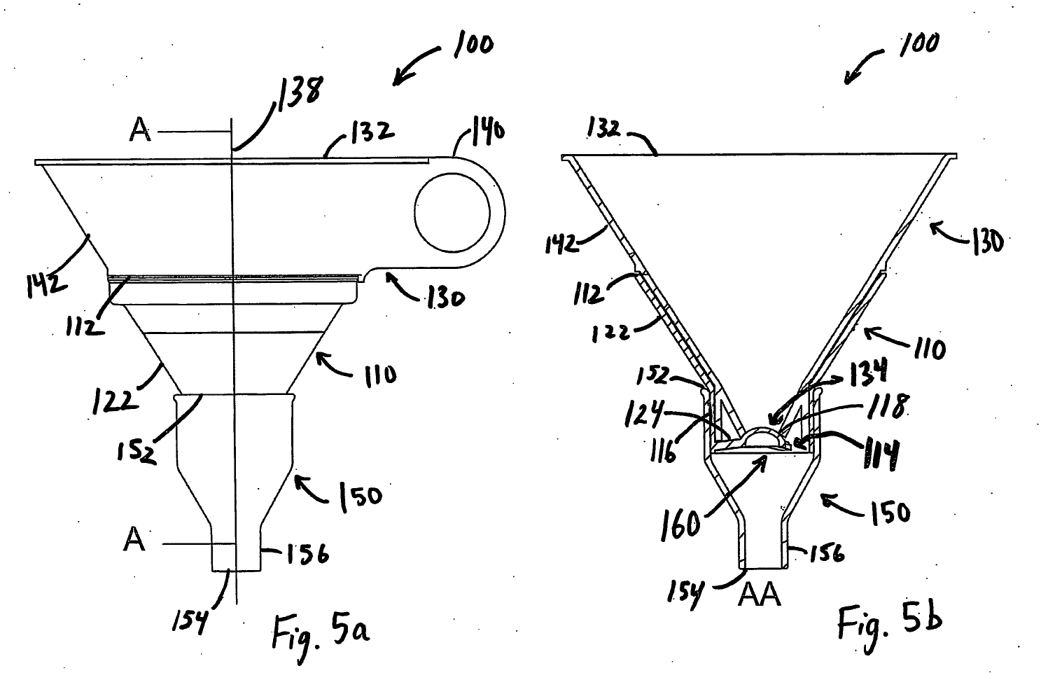

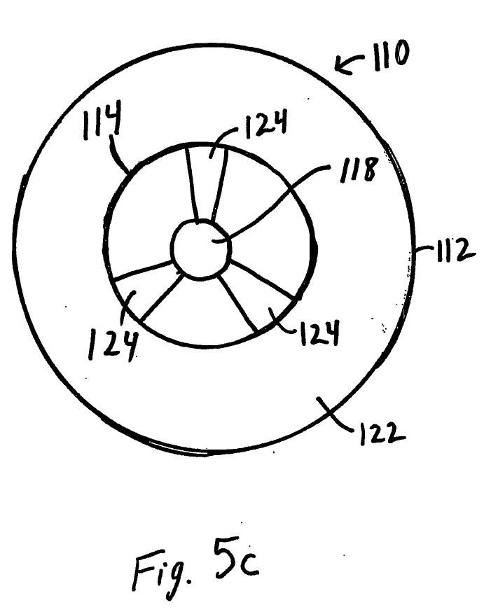

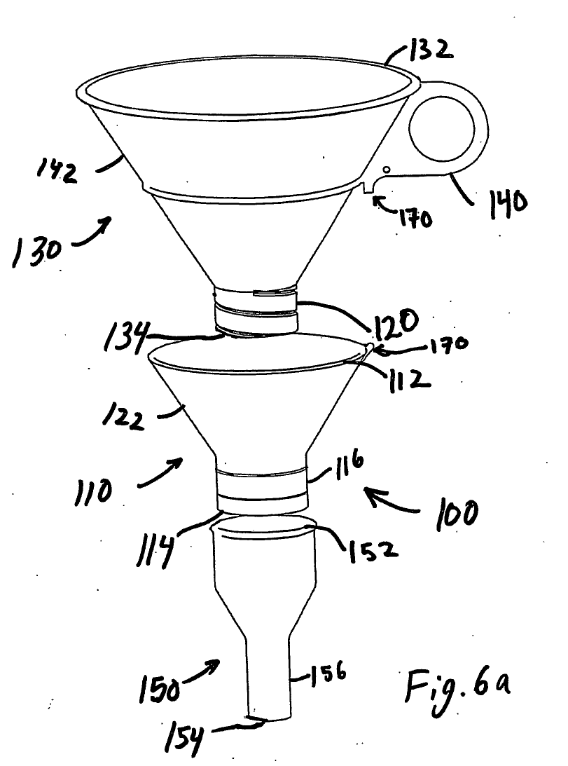

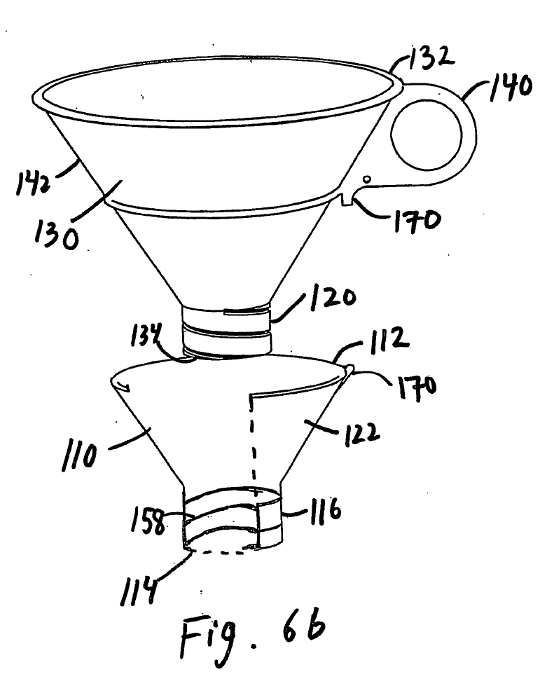

Reference is made to FIGS. 1-4, which are side, front, top, and isometric view drawings, respectively, of a funnel 100 in accordance with one embodiment of the present invention. Other views of funnel 100 are shown in FIGS. 5a, 5b, 6a and 6b. Funnel 100 may include structures, possibly separable, for example, a first hollow frusto-conical structure 130 and a second hollow structure 110. First hollow frusto-conical structure 130 may include side walls 142, for example, which taper from an intake port 132 and which lead to an exit port 134 (visible in FIGS. 3, 5b, 6a, and 6b). The diameter, width, and/or size of exit port 134 may be smaller than that of intake port 132. Second hollow structure 110 may include side walls 122, for example, which taper from an intake port 112 and which lead to an exit port 114. The diameter, width, and/or size of exit port 114 may be smaller than that of intake port 112; however in other embodiments this need not be the case. Second hollow structure 110 may also include a depending cylindrical member 116 which may lead from exit port 114.

Funnel 100 may include some features disclosed in application serial number 11/703,842, filed on Feb. 8, 2007, entitled “Funnel System”, incorporated by reference herein in its entirety.

Second hollow structure 110 may be adapted for mating with first hollow frusto-conical structure 130. In some embodiments second hollow structure 110 is non-removably connected to hollow frusto-conical structure 130; in other embodiments the parts may be removable from one another. In one embodiment of the invention, side walls 122 of second hollow structure 110 may conform to the outer dimensions of side walls 142 of first hollow frusto-conical structure 130. For example, side walls 122 may have a frusto-conical shape. In some embodiments, first structure 130 may fit within second structure 110 so that exit port 134 of first structure 130 sits within exit port 114 of second structure 110.

When second structure 110 and first structure 130 are mated, a passage 160 may be created through second exit port 114 and first exit port 134. When mating, second hollow structure 110 may rotate with respect to first hollow frusto-conical structure 130 for opening and closing passage 160. In one embodiment, first structure 130 and second structure 110 have complementary threaded surfaces so that when the structures are rotated relative to one another, structure 110 moves axially towards or away from structure 130, moving a sealing structure or stopper (e.g., a sealing element or structure 118, discussed below) to open or close an opening. In a preferred embodiment of the present invention, when mated, intake port 132 of first structure 130 may extend beyond intake port 112 of second structure 110 in a direction distal to exit ports 134 and 114. In another embodiment of the present invention, intake port 132 of first structure 130 may not extend beyond intake port 112 of second structure 110.

A locking mechanism 170 shown in FIG. 1 may be used to lock first and second structures 130 and 110 in a mated position so that the two structures are affixed. However, even in embodiments of the invention that include a locking mechanism 170, second hollow structure 110 is free to rotate with respect to first hollow frusto-conical structure 130. In some embodiments, lock 170 may be formed as a stop, latch, or hook that may only prevent the relative movement or rotation of first and second structures 130 and 110 in a specific direction. For example, when rotating second structures 110 relative to first structure 130 in a first direction for sealing exit port 134, lock 170 may only prevent rotating in the first direction beyond the point of sealing passage 160. In such embodiments, second structure 110 may be free to rotate relative to first structure 130 in a second direction for example, for opening passage 160. A locking mechanism need not be used.

Reference is made to FIG. 5a, which is a side view drawing of funnel 100 having a reference axis A-A 138 in accordance with one embodiment of the present invention. Reference axis A-A 138 may be an axis of symmetry of funnel 100. For example, reference axis A-A 138 may be a center axis equidistant from walls 122 and/or 142, exit ports 114 and/or 134, and/or other structures. Axis A-A 138 may be an axis of rotation for the relative rotation of first and second structures 130 and 110.

Reference is made to FIG. 5b, which is a cross-sectional view drawing of funnel 100 taken along reference axis A-A 138 in accordance with one embodiment of the present invention. Funnel 100 may include a sealing element or structure 118. FIG. 5b shows sealing element 118 in one of a possibly continuous range of positions in which sealing element 118 is adapted to move (e.g., in a position sealing exit port 134). When second structure 110 is moved along axis A-A relative to structure 130, sealing element 118 may seal, close, stop, or plug exit port 134 and passage 160 (e.g., in the position shown in FIG. 5b) for preventing the flow of material therethrough and containing the material in funnel 100. Sealing element 118 may be or include a seal, a block, a bung, a stopper, a plug, a disk, or any other structure to seal funnel 100 (e.g., at a bottom opening such as exit port 134). In other positions (not shown in FIG. 5b) sealing element 118 may be spaced from exit port 134 and passage 160 may be open.

Reference is made to FIG. 5c, which is a top view drawing of second structure 110 in accordance with one embodiment of the present invention. Second structure 110 includes sealing element 118 held by or suspended from (e.g., along a center axis of) exit port 114 by one or more extensions, rods, or protruding structures 124. Sealing element 118 and/or protruding structures 124 may be formed integral to exit port 114 or may alternately be removable. The diameter, width and/or size of sealing element 118 may be smaller than the smallest width of second structure 110.

Typically sealing element 118 does not seal second structure 110. Sealing element 118 may be positioned for fitting exit port 134, but not blocking passage 160 and the flow of materials therethrough. Sealing element 118 may partially cover exit port 114 and may be moved (e.g., in a direction along reference axis A-A 138) to completely cover exit port 134 of funnel 100. Sealing element 118 may be a convex cap or stopper which may seal or cover exit port 134 to a sufficient degree without the use of a flexible (e.g., rubber) covering used in other sealers. Alternately element 118 may include flexible material.

In one embodiment, rotating second structure 110 with respect to first structure 130 may move sealing element 118 between a position spaced from first structure 130 and exit port 134 for opening passage 160 and a position against exit port 134 for sealing or stopping passage 160. When used herein, in some embodiments, a seal using element 118 may not produce a watertight seal, but rather a seal preventing powder from flowing. In alternate embodiments, a watertight seal may be created. When second structure 110 is rotated in a first direction relative to first structure 130, sealing element 118 may close exit port 134 and passage 160. When second structure 110 is rotated in a second direction relative to first structure 130, sealing element 118 may allow material to flow out of exit port 134 and second structure 110. For example, rotating second structure 110 with respect to first structure 130 may widen a gap between first and second structures 130 and 110 for opening passage 160. Rotating second structure 110 with respect to first structure 130 (e.g., in a different or opposite direction) may bridge or lessen a gap between sealing element 118 and exit port 134 for sealing passage 160. During such rotations, sealing element 118 may cause passage 160 created between exit ports 114 and 134 to change between a substantially open and a substantially closed position.

In one embodiment of the present invention, sealing element 118 may be formed as a concave structure comprising an outer surface for mating or fitting with exit port 134. In other embodiments, sealing element 118 may be formed into alternate shapes which close or seal exit port 134. In various embodiments, sealing element 118 may be formed as a cylinder, cone, truncated cone, rectangular prism, flat surface, or other shape. In such embodiments, exit port 134 may have a shape complementary to sealing element 118 to be closed thereby. In other embodiments, when first and second structures 130 and 110 are rotated relative to each other sealing element 118 may expand and contract (e.g., by a telescoping structure) or open and close. In this way, sealing element 118 may cause passage 160 to throttle between a substantially open and a substantially closed position.

FIG. 6a shows an exploded view and FIG. 6b shows a cutaway view of the parts of an embodiment of funnel 100 in accordance with one embodiment of the present invention. First structure 130 may include outer attachment surface 120 and structure 110 may include a complimentary inner attachment surface 158 (shown only in FIG. 6b), respectively, for joining, mating, attaching, or bonding to each other. In one embodiment, first and second hollow structures 130 and 110 may attach in a permanent or integral way. In another embodiment, the structures may be detachably affixed so that they may be used, stored, and/or cleaned as multiple and separate pieces.

In one of such embodiments, outer attachment surface 120 and inner attachment surface 158 may be threaded (e.g., having threading oriented in a helical or inclined planar pattern) with complementarily grooved surfaces for enabling the rotation of first structures 130 with respect to second structure 110. For example, when force or torque is applied (e.g., by rotating) in a direction along the threaded curve, the force may be translated to move sealing element 118 (not shown) in a different direction, for example, along the axis of rotation 138, described in reference to FIGS. 5a and 5b. Thus, rotating second structures 110 with respect to first structure 130 may move sealing element 118 between a position away or spaced from exit port 134 for opening passage 160 and a position towards or against exit port 134 for sealing passage 160. Rotating second structure 110 with respect to first structure 130 may press sealing element 118 with some force against exit port 134. In some embodiments, when sufficient force (e.g., torque) is applied, sealing element 118 may form a sufficiently tight seal with exit port 134 for preventing the flow of liquids through passage 160. In another embodiment, only one of outer attachment surface 120 and inner attachment surface 158 includes a continuously threaded groove, while the other surface includes intermittent or discontinuous threaded segments having spaces therebetween. The continuous threaded groove may hinge on the discontinuous threaded segments. For example, there may be approximately three discontinuous threaded segments on one of the threaded surfaces, approximately an inch in length and spaced approximately ¼ inch apart. In one embodiment, outer attachment surface 120 may include three partial threads, each extending less than 120 degrees around the circumference of the opening. Other numbers or types of discontinuous threads may be used, and a discontinuous thread need not be used.

Each of outer attachment surface 120 and inner attachment surface 158 may have relatively complementary threaded regions defined by a measure, such as for example, threads per inch (TPI), which is a count of the number of threads along an inch of the threaded region, and/or thread pitch, which is a distance (e.g., in millimeters) between threads (e.g., each measured in a direction along reference axis A-A 138). A higher density of threads along the length of outer attachment surface 120 and/or inner attachment surface 158 may correspond to higher TPI and lower thread pitch measurements. Other measurements may be used, such as, the total length of a thread or threaded area, the length of a thread segment spiraling 360°, the length of a thread segment along which second structure 110 rotates by a full turn or 360° relative to first structure 130, a rotational angle of the helical pattern of the threaded area, and the width, diameter, radius, and/or surface area of the threaded regions (e.g., outer attachment surface 120 and/or outer attachment surface 120) or any complementary, mated, or adjacent structures. In one exemplary embodiment, each of outer attachment surface 120 and inner attachment surface 158 have a thread count of approximately 1-10 TPI. In one exemplary embodiment, the thread count is approximately 4 TPI. In one exemplary embodiment, the length (e.g., measured in a direction along reference axis A-A 138) and diameter (e.g., measured in a direction perpendicular to reference axis A-A 138) of outer attachment surface 120 and outer attachment surface 120 are approximately 11/16 inches and 1¼ inches, respectively. In one exemplary embodiment, the angle of the threading grooves (e.g., measured relative to the direction perpendicular to reference axis A-A 138) is approximately 5 degrees. Other dimensions or measurements may be used.

The second hollow frusto-conical structure 130 may include one or more measuring scale(s) 136. An embodiment of the measuring scale 136 is shown in FIG. 3. The measuring scale 136 may be for example a volumetric scale useful for determining the quantity of material within funnel 100. The measuring scale(s) 136 may be a liquid scale with labels such as teaspoons, tablespoons, ounces, cups, pints, quarts, milliliters, liters, or the like. The measuring scale(s) 136 may alternately or additionally be a solid (or dry) scale with labels such as ounces, pounds, grams, kilograms, or the like in which the scale is based on the density of a specific solid (or dry) material to be measured. Other measurement scales or devices may be used.

First hollow frusto-conical structure 130 or second structure 110 may include one or more handle(s) 140. Handle 140 may be used to ease rotating second hollow structure 110 with respect to first hollow frusto-conical structure 130. Handle 140 may also be used for transporting funnel 100. Handle 140 may be solid or may have a through-hole which may be used to hang funnel 100 on a hook. The through-hole may also be sized for the finger or fingers of a user. Two handles—one on each structure 110 and 130—may be used. First hollow frusto-conical structure 130 may have a spout (not shown), for example, positioned on the brim of intake port 132, that may be used for pouring materials from funnel 100.

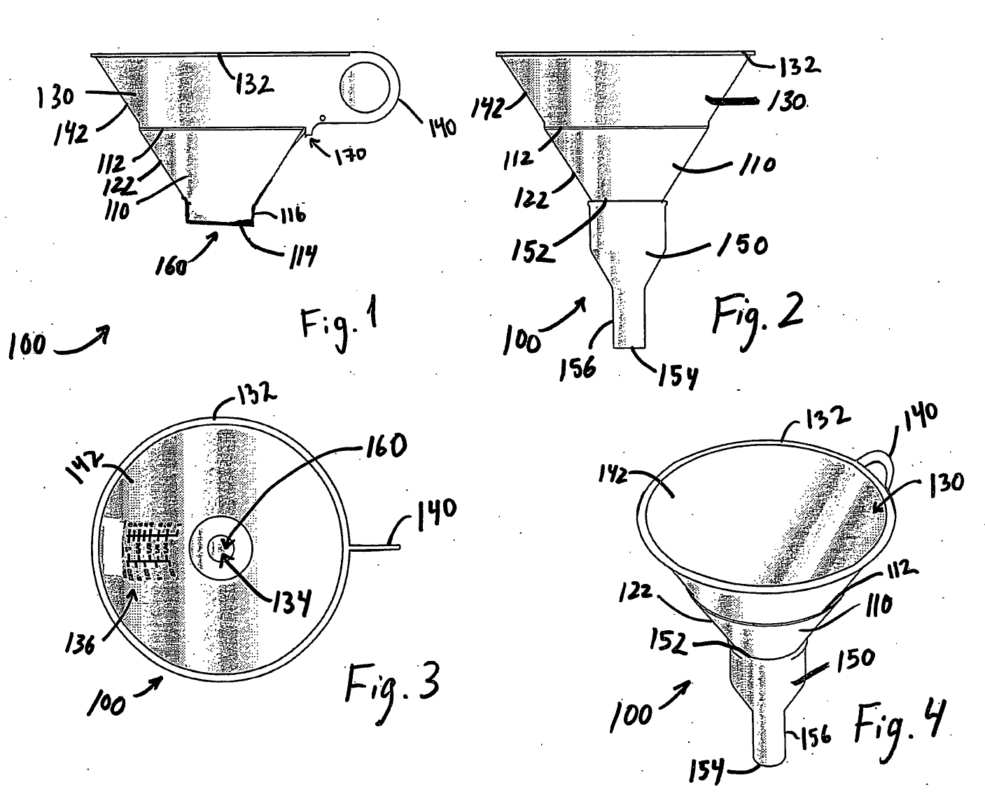

In some embodiments of the present invention, funnel 100 may include one or more attachments, such as a hollow exit port attachment 150 (e.g., a third hollow structure) adapted for mating with exit port 114 of the second hollow structure 110. Hollow exit port attachment 150 is shown in FIGS. 2 and 4-6. Attachments need not be used. Hollow exit port attachment 150 may include an intake port 152, an exit port 154, and a depending cylindrical member 156. The diameter, width, and/or size of exit port 154 may be smaller than that of exit port 114. In some embodiments, depending cylindrical member 156 may be narrower than exit port 114 of second structure 110 in order to allow funnel 100 to be used with containers having a narrower opening. In other embodiments of the present invention, the depending cylindrical member 156 may be wider than the exit port 114 of the first frusto-conical structure 110 in order to allow funnel 100 to be used with containers having a wider opening. In yet another embodiment, the diameter, width, and/or size of exit port 154 may be altered. For example, exit port 154 may include a telescoping truncated conical structure that may be raised or lowered, rotated inward or outward or adjusted using other motions to expand or contract exit port 154. For example, exit port 154 may be fitted to approximately the same size as a container to which material is being dispensed for funnel 100 to form a seal with the container. Such a seal may prevent, for example, highly volatile materials from escaping into a surrounding area or atmosphere. The telescoping structure may expand or contract the dimensions of exit port 154 using a rotation mechanism similar to the mechanism for moving sealing element 118. In one embodiment, the same rotating motion that moves sealing element 118 may change the size of exit port 154.

Intake port 152 may be adapted for attachment with second hollow structure 110. For example, second structure 110 and intake port 152 may have complementary threaded surfaces for joining. In some embodiments of the present invention, a locking mechanism (not shown but similar to locking mechanism 170) may be used to lock hollow exit port attachment 150 and second hollow structure 110 in a mated position so that the two cannot be separated. Another mechanism, such as a friction fit mechanism, may be used to attach port 152 and structure 110.

First hollow frusto-conical structure 130, second hollow structure 110, and hollow exit port attachment 150 may be made from a wide variety of materials such as glass, plastic, ABS, stainless steel, or the like. The material may be non-reactive and/or non-volatile, and food-safe. Further, not all of the components of funnel 100 need be made from the same materials. For example, first structure 130 may be made of glass and second structure 110 may be made of plastic. Second structure 110 may be made of one unitary structure, without any additional material (e.g., rubber); alternately, multiple parts and materials may be used. Clear materials may be preferred in order to view the volume of the material within funnel 100 with measuring scale(s) 136.

Funnel 100 may be used both to measure or load a volume of material from a first container and to dispense the material into a second container. In such an embodiment, first hollow frusto-conical structure 130 is first rotated with respect to second hollow structure 110. The rotation may move or secure sealing element 118 to a position against exit port 134 for sealing or closing passage 160. Once the passage 160 is substantially closed, a material such as a liquid or a granular or melting solid (e.g., sugar, flour, soil, or other materials) may be introduced into intake port 132 of the first hollow frusto-conical structure 130. Since passage 160 is substantially closed, the material will remain within funnel 100. In some embodiments, the material may then be measured using measuring scale(s) 136; measuring need not be performed. Material may then be removed or added to funnel 100 based upon whether too much or too little material has been introduced into funnel 100. Once the desired measure of material is within funnel 100, the exit port 114 of second hollow structure 110 may be aligned with the opening of a second container. Optional depending cylindrical member 116 or optional hollow exit port attachment 150 may be used to aid in the alignment of funnel 100 if the material contained therein is to be discharged into a container. Once aligned, second hollow structure 110 is rotated with respect to first hollow frusto-conical structure 130. The rotation may move sealing element 118 from a position against exit port 134 for sealing passage 160 to a position spaced from first structure 130 (e.g., or exit port 134) for opening passage 160. This rotation may be in the same direction as the first rotation or in a different direction. During this second rotation, passage 160 created between exit ports 114 and 134 is changed from the substantially closed condition to a substantially open condition. As passage 160 is opened, the material within funnel 100 may be discharged therefrom. For example, the material may be introduced into a container by way of exit port 114 of second hollow structure 110.

Various structures or elements (not shown) which alter the material as it is introduced into the second container may be incorporated into funnel 100. Such structures may be a permanent part of funnel 100 or may be optionally attached or interchangeably exchanged. The physical location of these structures will depend upon the structure, but they may be incorporated in or attached to exit port 114 or 134, sealing element 118, hollow cylindrical depending member, hollow exit port attachment 150 or other members of funnel 100. An exemplary embodiment of such an element is an aerator which introduces air into a material as it exits funnel 100. Such an element may be useful for wines or other beverages. Another exemplary embodiment of an additional structure may be a strainer which only allows material of a certain dimension to pass through funnel 100. Such a structure may be useful for creating a sieve or for removing sediment from a liquid. In one embodiment, rotating second structure 110 with respect to first structure 130 may force a clamp or sieve to press against a material held in first hollow frusto-conical structure 130 for extracting liquid through passage 160. Another exemplary embodiment of such an element is a sifter which may be useful for both aerating a material and allowing material of only a certain dimension to pass through funnel 100. Other structures may also act upon material exiting funnel 100. Alternately, structures may be employed which act upon the material while still within funnel 100. Such structures may include mixers or separators.

Funnel 100 need not be used for measurement, and measuring marks (e.g., such as measuring scale 136) need not be included.

While the invention has been described with respect to a limited number of embodiments, it will be appreciated that many variations, modifications and other applications of the invention may be made. Embodiments of the present invention may include other apparatuses for performing the operations herein. Such apparatuses may integrate the elements discussed, or may comprise alternative components to carry out the same purpose. It will be appreciated by persons skilled in the art that the appended claims are intended to cover all such modifications and changes as fall within the true spirit of the invention.

What is claimed is:

1. A funnel comprising:
a first hollow frusto-conical structure comprising an intake port and a first exit port, wherein the diameter of said first exit port is smaller than the diameter of said intake port;
a second hollow structure comprising a sealing element for sealing said first exit port, wherein said second structure is adapted for mating with said first structure for forming a passage from said first structure through said second structure and wherein rotating said second structure with respect to said first structure bridges a gap between said sealing element and said first exit port for sealing said passage.

2. The funnel of claim 1, wherein rotating said second structure with respect to said first structure widens said gap for opening said passage.

3. The funnel of claim 1, wherein said first structure and said second structure comprise complementary threaded surfaces.

4. The funnel of claim 1, wherein said sealing element is concave and comprises an outer surface for mating with said first exit port.

5. The funnel of claim 1, wherein said sealing element is held along a center axis of said first exit port.

6. The funnel of claim 1, further comprising a third hollow structure comprising an intake port and an exit port, wherein said intake port is adapted for attachment with said second hollow structure and said exit port has a diameter less than said diameter of said first exit port.

7. The funnel of claim 1, further comprising a locking mechanism for detachably affixing said first structure to said second structure when said structures are mated.

8. A funnel comprising:
a first hollow frusto-conical structure comprising an intake port and a first exit port;
a second hollow structure comprising a stopper, wherein said second structure is adapted for connecting with said first structure for forming a passage allowing material to flow from said intake port through said second structure, and wherein rotating said second structure with respect to said first structure moves said stopper between a position spaced from said first structure for opening said passage and a position against said first exit port for sealing said passage.

9. The funnel of claim 8, wherein said first structure and said second structure comprise complementary threaded surfaces.

10. The funnel of claim 8, wherein said stopper is concave and comprises an outer surface for mating with said first exit port.

11. The funnel of claim 8, wherein said stopper is held along a center axis of said first exit port.

12. The funnel of claim 8, further comprising a third hollow structure comprising an intake port and an exit port, wherein said intake port is adapted for attachment with said second hollow structure and said exit port has a diameter less than said diameter of said first exit port.

13. The funnel of claim 8, further comprising a handle attached to said second hollow structure.

14. The funnel of claim 8, further comprising a locking mechanism for detachably affixing said first structure to said second structure when said structures are mated.

15. A funnel comprising:
an intake port and an exit port, the width of the intake port being larger than the width of the exit port;
a hollow structure comprising a sealing structure, the width of the sealing structure being smaller than the smallest width of the hollow structure and not sealing the hollow structure, the sealing structure to close the exit port when the hollow structure is rotated in a first direction and the sealing structure to allow material to flow out of the exit port and through the hollow structure when the hollow structure is rotated in a second direction.

16. The funnel of claim 15, wherein rotating the hollow structure in the first direction moves the sealing structure towards the exit port.

17. The funnel of claim 15, wherein the sealing structure is concave and comprises an outer surface for mating with the exit port.

18. The funnel of claim 15, wherein the sealing structure is held along a center axis of the exit port.

19. The funnel of claim 15, further comprising a second intake port and a second exit port, wherein the second intake port is adapted for attachment with the hollow structure and the width of the second exit port being smaller than the smallest width of the funnel.

20. The funnel of claim 15, further comprising a locking mechanism for detachably affixing said hollow structure to said exit port when said structures are mated.
